(19) United States
(12) Patent Application Publication
(10) Pub. No.: US 2014/0200942 A1
(43) Pub. Date: Jul. 17, 2014

(54) METHOD AND SYSTEM FOR MANAGING SCHEDULES

(71) Applicant: Edward Benjamin, Chestnut Hill, MA (US)

(72) Inventor: Edward Benjamin, Chestnut Hill, MA (US)

(21) Appl. No.: 14/155,755

(22) Filed: Jan. 15, 2014

Related U.S. Application Data
(60) Provisional application No. 61/752,736, filed on Jan. 15, 2013.

(51) Int. Cl. G06Q 10/10

(52) U.S. Cl. CPC G06Q 10/1093
USPC 705/7.18

(57) ABSTRACT

A system is provided that enables a user to manage schedules. An interface may be provided that allows for simultaneous display of multiple calendars within the interface and interaction between them. The interaction may include dragging and dropping events from one calendar to the other. The dragging and dropping of events can indicate different actions for different contexts.

### RELATED APPLICATIONS

This application claims priority under 35 U.S.C. §119(e) to U.S. Provisional Patent Application Ser. No. 61/752,736, entitled “METHOD AND SYSTEM FOR MANAGING SCHEDULES,” filed on Jan. 15, 2013, which application is herein incorporated by reference in its entirety.

### FIELD OF THE INVENTION

This application relates to methods and systems that enable a user to manage schedules.

### BACKGROUND

Conventional systems and applications directed toward managing schedules typically include a calendar. The calendar often includes events, which can include appointments, reminders, meetings, functions, and other items having a time and/or date component. Users generally interact with the calendar using views that show a day, week, or month-long timeframe. The users get a sense of upcoming events on their calendars with these different timeframe views. Users can also enter events on their calendars, as well as modify existing events on their calendars. Some applications allow users to view other calendars, such as calendars of coworkers to see when a meeting might best be scheduled.

### SUMMARY

According to aspects of the present disclosure, a system is provided that enables a user to easily manage schedules. Specifically, the system provides for an interface which allows a user to see a plurality of calendars simultaneously and allow for interaction between the calendars. The calendars can include the user's personal calendar shown alongside a second calendar. The second calendar can be a calendar of a friend, a group, an organization, a school, a business, or other appropriate entity. The interaction can include dragging and dropping events from one calendar to the other calendar. The dragging and dropping of events can indicate different actions for different contexts. For example, dragging and dropping of an event from a school calendar to a personal calendar can indicate an RSVP to the event. Dragging and dropping of an event from a personal calendar to a friend's calendar can indicate an invitation to an event. Dragging and dropping of an event from a personal calendar to a group calendar can indicate a creation of an event and/or an invitation for group members to the event. Dragging and dropping of an event from a business calendar to a school calendar can indicate an advertisement of an event. Further examples will be discussed in greater detail below.

In some embodiments, one of the calendars can be a community calendar, such as a college campus. The community can be made up individuals and smaller groups within the community. The community calendar can display community-wide events, including events to being held by the smaller groups included in the community, as well as events made public by individuals. The community calendar can receive RSVP information from users, for example, based on interactions with the community calendar. The community calendar can also display how popular events are. In some embodiments, one of the calendars can display the most popular events from groups within the community.

In some embodiments, local businesses can also have calendars. Business calendars can display events held and/or sponsored by the business, as well as promotions, specials, and other information provided by the business. Business events can also be displayed on the community calendar. In some embodiments, businesses can pay to advertise events on the community calendar.

The system can include one or more servers, hosting and storing information related to the users, community, groups, and business calendars. Users, including businesses, can interact with the server system over a network, such as the Internet, using client devices. Client devices can include computers, laptops, smart phones, tablets, netbooks, and any other appropriate data processing machine. The servers can provide, via the network, a user interface, through which the users can receive and input information into the system.

According to one aspect, a method for managing schedules is provided. The method comprises an act of providing, by a server system to a computer, a user interface displaying at least a first and a second calendar, the user interface providing for interaction by a user between the first calendar and the second calendar to affect events on at least one of the first and the second calendars. In one embodiment, the first calendar is a personal calendar of the user. In one embodiment, the second calendar is associated with an entity including at least one of a group comprising a friend, a group, an organization, a school, and a related entity. In one embodiment, the method further comprises an act of providing, to the user, a capability for dragging and dropping events between the first calendar and the second calendar. In one embodiment, the method further comprises an act of sending, responsive to an act of dragging and dropping an event to the first calendar, a message indicating that the user is attending the event. In one embodiment, the method further comprises an act of advertising an event, responsive to the act of dragging and dropping the event to the first calendar. In one embodiment, the method further comprises an act of receiving an advertising payment for displaying one or more events on the second calendar. In one embodiment, the method further comprises an act of performing an action responsive to the act of dragging and dropping an to event to the first calendar. In one embodiment, the first calendar is a public calendar accessible by other users and wherein the user is permitted to post an event to the public calendar.

According to one aspect, a system for managing schedules is provided. The system comprises a processor; a memory coupled to the processor; a storage system configured to store a plurality of events associated with one or more people and activities; an interface adapted to display at least a first calendar and a second calendar, the interface providing for interaction by a user between the first calendar and the second calendar to affect events on at least one of the first and second calendars. In one embodiment, the first calendar is a personal calendar of the user. In one embodiment, the second calendar is associated with an entity including at least one of a group comprising a friend, a group, an organization, a school, and a related entity. In one embodiment, the interface is adapted to permit the user to drag and drop events between the first calendar and the second calendar. In one embodiment, the processor is operative to send a message indicating that the user is attending an event responsive to the user dragging and dropping the event to the first calendar. In one embodiment, the processor is operative to display an advertisement for an event responsive to dragging and dropping the event to the first calendar. In one embodiment, the system further comprises a component adapted to receive a payment for displaying one or more events on the second calendar. In one embodiment, the processor is operative to perform an action responsive to a drag and drop of an event to the first calendar. In one embodiment, the action is determined based on a context of the event being placed within the interface.

Additional aspects and features of the scheduling system are detailed below with reference to example embodiments.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is to illustrated in various figures is represented by a like numeral. For purposes of clarity, not every component may be labeled in every figure. In the figures:

FIG. 1 is an example interface according to one embodiment of the present invention;

FIG. 2 is another example interface according to one embodiment of the present invention;

FIG. 3 is an example computer system upon which various embodiments of the present invention may be practiced;

FIG. 4 is an example login interface according to one embodiment of the present invention;

FIG. 5 is an example interface according to one embodiment of the present invention;

FIG. 6 is an example mobile interface according to one embodiment of the present invention;

FIG. 7 is another example interface according to one embodiment of the present invention;

FIG. 8 another example interface according to one embodiment of the present invention; and

FIG. 9 shows an example process of working with calendars in accordance with one embodiment of the present invention.

### DETAILED DESCRIPTION

Various examples and embodiments illustrating aspects of management of a scheduling system are described and shown below. However, it is to be appreciated that the invention is not limited to the specific configurations and implementations discussed herein, but rather, the following examples are provided for the purposes of explanation and illustration only.

In some embodiments, the scheduling system can include a community calendar, such as a college campus. A college can include students, each with individual personal calendars. The college can also include various groups, also with schedules of events. Groups can include sports teams, fraternities, sororities, student groups, faculty groups, living groups, majors, departments, and other organizations affiliated with the college. Groups can also include less formal and/or official groups, such as a specific group of students who are friends, a group of roommates, a study group, or other such groups.

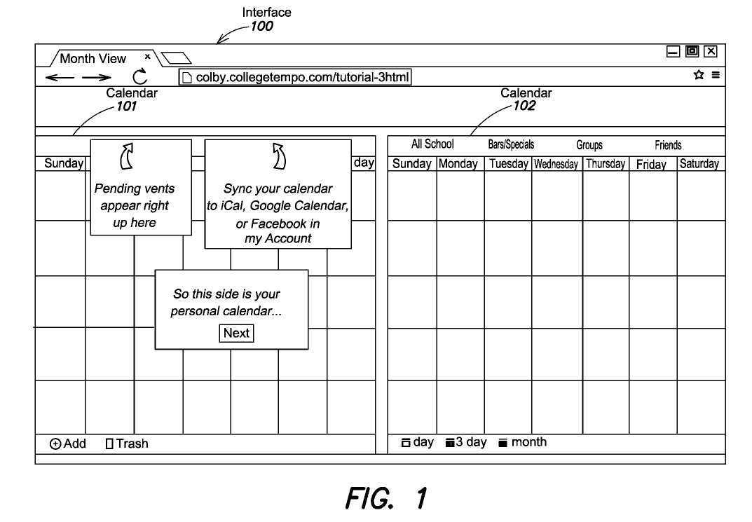

Referring to FIG. 1, the scheduling system includes a user interface 100, which displays calendars to the user.

The user interface can display two or more calendars at once, for example, a first calendar 101 and a second calendar 102. The first calendar 101 can be the user's personal calendar, for example, the calendar displayed on the left. The personal calendar can display the user's upcoming events. Events can include appointments, meetings, reminders, time blocked off for specific activities, and other commitments and items including a time and/or date component. The personal calendar can sync with other existing calendaring systems, such as iCal, Google Calendar, Facebook, Outlook, or other appropriate systems. Syncing calendars can allow the user to enter, modify, or delete events on the user interface and have the events appear and/or on other calendaring systems. Conversely, the user can enter, modify, or delete events on other calendaring systems and have the events appear and/or change on the user interface.

Both the first and second calendars can include different views for different timeframes. For example, FIG. 1 shows a month view. The calendar can also show a week, a day, several days, several weeks, several months, or a year at a time. In some embodiments, the user can configure different timeframe views. For example, the weekdays and the weekend can be separated into two different timeframe views. Some users may want to see three days at a time. Other appropriate timeframes can be used. In some embodiments, the first and second calendar change to show the same timeframe views. In some embodiments, the first and second calendars can show different timeframe views.

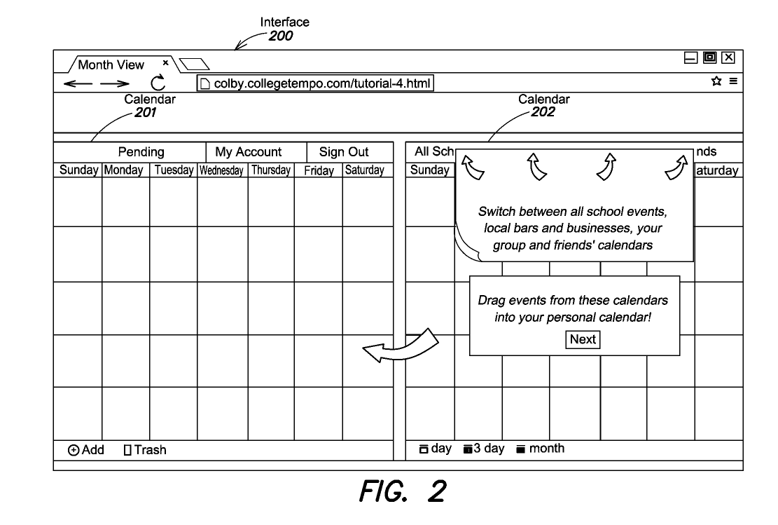

FIG. 2 shows another embodiment of an interface (e.g., interface 200) that includes a first calendar 201 associated with the user (e.g., a personal calendar) and a second calendar 202.

Referring to FIG. 2, a second calendar 202 can be toggled between several calendars. For instance, the user can change the display of the user interface so the second calendar 202 is a community calendar, a group calendar, a business calendar, or a friend's calendar. For example, for a college community, the community calendar can be an all-school calendar, which can show all the events happening at school in the chosen timeframe. Users can select events of interest to the user and drag the event from the all-school calendar on the right to the user's personal calendar on the left. Dragging and dropping an event from the all-school calendar to the personal calendar can indicate that the user plans on attending the event. The event host can receive an RSVP from the user, and the event can appear on the user's personal calendar to provide a reminder that the user is planning to attend.

The events can include official school events, such as commencement, or exam schedules. The events can also include events aggregated from the group calendars. For example, the all-school calendar can include all events from all officially school-affiliated groups on campus. For example, the all-school calendar can include sports events, fraternity and sorority events, student group events, faculty and department group events, while not aggregating events for less official groups, such as a group of roommates having dinner.

In some embodiments, the all-school calendar aggregates and displays events that are designated as public, while not displaying events that are designated as private. Groups can also be designated as public or private. For example, official school-affiliated groups can be designated as public, while less official and/or formal groups can be designated as private. The designation of the group can provide a default status for the events of the group. For example, public groups can create public events by default, while private groups can create private events by default. Users can change the default designation of the events so that public groups can have private events (e.g., a student group's governing body meeting), and private groups can have public events.

### Example Computer Implementations

Processes described above are merely illustrative embodiments of systems that may provide recommendations in association with a system to manage schedules. Such illustrative embodiments are not intended to limit the scope of the present invention, as any of numerous other implementations for performing the invention. None of the claims set forth below are intended to be limited to any particular implementation of a method of providing player incentives, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Further, on each of the one or more computer systems that include one or more components of a distributed system, each of the components may reside in one or more locations on the system. For example, different portions of the components of the system may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers to such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the location-based services with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system. The computer system may include a processor connected to one or more memory devices, such as a disk drive, memory, or other device for storing data. Memory is typically used for storing programs and data during operation of the computer system. Components of the computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components of the system. The computer system also includes one or more input devices, for example, a keyboard, mouse, trackball, microphone, touch screen, and one or more output devices, for example, a printing device, display screen, and/or speaker. In addition, the computer system may contain one or more interfaces (not shown) that connect the computer system to a communication network (in addition or as an alternative to the interconnection mechanism).

The storage system typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory to element, and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

The computer system may be a general-purpose computer system that is programmable using a high-level computer programming language. The computer system may be also implemented using specially programmed, special purpose hardware. In the computer system, the processor is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS Snow Lion operating systems available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems to that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

Aspects of the invention may also be performed on mobile computing devices, such as smart phones, netbooks, tablet computers, and any other device including a processor and communication capabilities.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

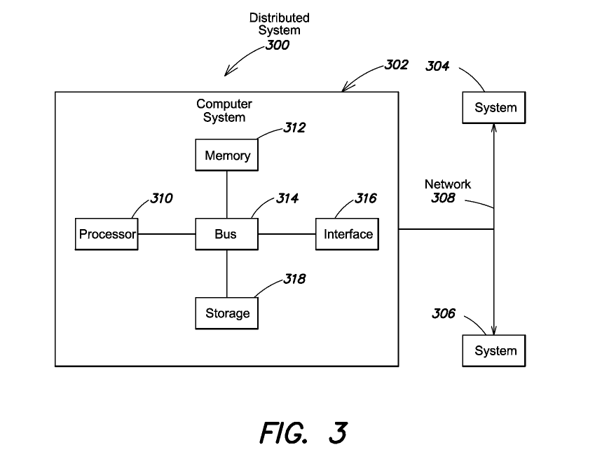

FIG. 3 shows a block diagram of a distributed computer system 300, in which various aspects and functions in accord with the present disclosure may be practiced. The distributed computer system 300 may include one more computer systems. For example, as illustrated, the distributed computer system 300 includes three computer systems 302, 304 and 306. As shown, the computer systems 302, 304 and 306 are interconnected by, and may exchange data through, a communication network 308. The network 308 may include any communication network through which computer systems may exchange data. To exchange data via the network 308, the computer systems 302, 304 and 306 and the network 308 may use various methods, protocols and standards including, among others, token ring, Ethernet, Wireless protocols, Bluetooth, TCP/IP, UDP, HTTP, FTP, SNMP, SMS, MMS, SS7, JSON, XML, REST, SOAP, CORBA HOP, RMI, DCOM, and Web Services. To ensure data transfer is secure, the computer systems 302, 304 and 306 may transmit data via the network 308 using a variety of security measures including TSL, SSL, or VPN, among other security techniques. While the distributed computer system 300 illustrates three networked computer systems, the distributed computer system 300 may include any number of computer systems, networked using any medium and communication protocol.

Various aspects and functions in accord with the present disclosure may be implemented as specialized hardware or software executing in one or more computer systems including the computer system 302 shown in FIG. 3. As depicted, the computer system 302 includes a processor 310, a memory 312, a bus 314, an interface 316 and a storage system 318. The processor 310, which may include one or more microprocessors or other types of controllers, can perform a series of instructions that manipulate data. The processor 310 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. The processor 310 may be a mobile device or smart phone processor, such as an ARM Cortex processor, a Qualcomm Snapdragon processor, or an Apple processor. As shown, the processor 310 is connected to other system placements, including a memory 312, by the bus 314.

The memory 312 may be used for storing programs and data during operation of the computer system 302. Thus, the memory 312 may be a relatively high performance, volatile, random access memory such as a dynamic random access memory (DRAM) or static memory (SRAM). However, the memory 312 may include any device for storing data, such as a disk drive or other non-volatile storage device, such as flash memory or phase-change memory (PCM). Various embodiments in accord with the present disclosure can organize the memory 312 into particularized and, in some cases, unique structures to perform the aspects and functions disclosed herein.

Components of the computer system 302 may be coupled by an interconnection element such as the bus 314. The bus 314 may include one or more physical busses (for example, busses between components that are integrated within a same machine), and may include any communication coupling between system placements including specialized or standard computing bus technologies such as IDE, SCSI, PCI and InfiniBand. Thus, the bus 314 enables communications (for example, data and instructions) to be exchanged between system components of the computer system 302.

Computer system 302 also includes one or more interface devices 316 such as input devices, output devices, and combination input/output devices. The interface devices 316 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 316 allow the computer system 302 to exchange information and communicate with external entities, such as users and other systems.

Storage system 318 may include a computer-readable and computer-writeable nonvolatile storage medium in which instructions are stored that define a program to be executed by the processor. The storage system 318 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk, or flash memory, among others. In operation, the processor 310 or some other controller may cause data to be read from the nonvolatile recording medium into another memory, such as the memory 312, that allows for faster access to the information by the processor 310 than does the storage medium included in the storage system 318. The memory may be located in the storage system 318 or in the memory 312. The processor 310 may manipulate the data within the memory 312, and then copy the data to the medium associated with the storage system 318 after processing is completed. A variety of components may manage data movement between the medium and the memory 312, and the disclosure is not limited thereto.

Further, the disclosure is not limited to a particular memory system or storage system. Although the computer system 302 is shown by way of example as one type of computer system upon which various aspects and functions in accord with the present disclosure may be practiced, aspects of the disclosure are not limited to being implemented on the computer system, shown in FIG. 3. Various aspects and functions in accord with the present disclosure may be practiced on one or more computers having different architectures or components than that shown in FIG. 3. For instance, the computer system 302 may include specially-programmed, special-purpose hardware, such as for example, an application-specific integrated circuit (ASIC) tailored to perform a particular operation disclosed herein. Another embodiment may perform the same function using several general-purpose computing devices running processors having one or more operating systems and several specialized computing devices running proprietary hardware and operating systems.

The computer system 302 may include an operating system that manages at least a portion of the hardware placements included in computer system 302. A processor or controller, such as processor 310, may execute an operating system which may be, among others, a Windows-based operating system (for example, Windows XP, Windows 7, or Windows 8) available from the Microsoft Corporation, a MAC OS System X operating system available from Apple Computer, one of many Linux-based operating system distributions (for example, the Enterprise Linux operating system available from Red Hat Inc.), or UNIX operating systems available from various sources. The operating system may be a mobile device or smart phone operating system, such as Windows Mobile, Android, or iOS. Many other operating systems may be used, and embodiments are not limited to any particular operating system. The computer system 302 may include a virtualization feature that hosts the operating system inside a virtual machine (e.g., a simulated physical machine). Various components of a system architecture could reside on individual instances of operating systems inside separate “virtual machines”, thus running somewhat insulated from each other.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present disclosure may be implemented using an object-oriented programming language, such as JAVA, C++, Ada, or C# (C-Sharp). Other object-oriented to programming languages may also be used. Alternatively, procedural, scripting, or logical programming languages may be used.

Additionally, various functions in accord with aspects of the present disclosure may be implemented in a non-programmed environment (for example, documents created in HTML, XML or other format that, when viewed in a window of a browser program, render aspects of a graphical-user interface or perform other functions). Further, various embodiments in accord with aspects of the present disclosure may be implemented as programmed or non-programmed placements, or any combination thereof. For example, a web page may be implemented using HTML while a data object called from within the web page may be written in C++. Thus, the disclosure is not limited to a specific programming language and any suitable programming language could also be used.

A computer system included within an embodiment may perform functions outside the scope of the disclosure. For instance, aspects of the system may be implemented using an existing product, such as, for example, the Google search engine, the Yahoo search engine available from Yahoo! of Sunnyvale, Calif., or the Bing search engine available from Microsoft of Seattle Wash. Aspects of the system may be implemented on database management systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. One or more systems may be implemented as cloud-based applications and/or have cloud-based databases and/or storage services.

### Additional Embodiments

Below are described additional embodiments of the present invention that may be practiced alone or in combination with other embodiments. In one embodiment, a college-related calendar may be created termed “CollegeTempo” that may serve a college community, college groups as well as individual students. In one embodiment, CollegeTempo may serve as both a personal and a community calendar that instantaneously links multiple student calendars to create a master calendar with real time attendance and popularity statistics. For a student user, according to one specific implementation, the personal calendar is always present on the left half of the page. In addition, in this implementation, four types of social calendars are rotated on the right half of the page. The types of social calendars are as follows: all-school to public calendars, bars and local business calendars, group calendars, and friends' calendars. Users schedule their lives by posting their daily personal commitments (homework, classes, lunch) into their personal calendar, and by dragging social events (parties, local bar promotions, community service projects, sports games, rehearsals, practices, small group meetings, study groups, lunch with friends), from their various social calendars into their own planner and from their own planner into the calendars of their friends.

By dragging any social event from the right half of the page into one's personal calendar on the left, the user RSVPs to that event, organizing his own life while letting his friends know what he is doing. Accoring to one embodiment, a CollegeTempo system may allow students to create their own group calendars (for sports teams, study groups, class projects, roommate get-togethers, etc.) so that organizing multiple events for a particular friend group or organization is as easy as dragging an icon. Notably, complex actions may be performed as a result of a drag and drop of an event between the calendars. An interface may be provided where the dragging and dropping of events onto calendars causes other actions to be performed (e.g., an RSVP to be sent). For example, creating an event in a group calendar, all members of that group will be able to view the event and can similarly RSVP to that event by dragging the event into their personal calendar. The CollegeTempo system may also allow students to “friend” classmates and friends, enabling them to view each other's personal calendars and share and expose public events to each other.

According to various embodiments, a CollegeTempo system may provide one or more of the following aspects:

Personal Calendars, for both students and businesses.

Calendar Sharing—drag and drop within groups and between individuals.

All-School Public Calendars.

“Groupon” type Crowd Deals hosted by both businesses and students.

Mobile Application.

Security and Privacy Concerns.

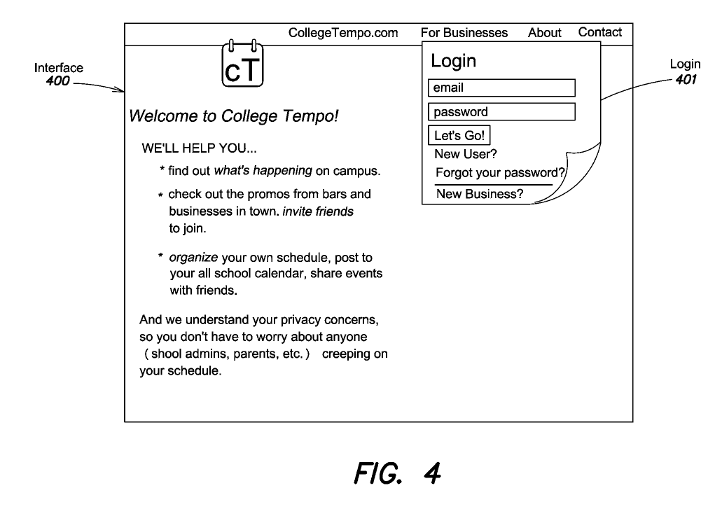

According to several embodiments, the CollegeTempo system may provide one or more pages through which users interact. An intro page may be provided that serves as the first page and the entry point into the CollegeTempo system for first time users. For example, FIG. 4 shows an example of interface 400 The CollegeTempo system may also include a login page or area (e.g., login 401) that displays any into page information, along with a brief to message will be displayed for students, and may prompt the user to enter his/her name, email and password. A valid college email address will ensure that only members of the community will be able to access A CollegeTempo system. If the user already has an account and has turned on the “remember me,” he or she may be directly sent to the calendar homepage. Once a new user enters his or her information on the intro page, he or she may be directed to their homepage where they can begin building their calendar. Other buttons on the into page may include: “About,” “For Businesses,” and “Contact” may be located below the sign in. By clicking on “For businesses,” the page may change with a different message, outlining how a CollegeTempo system provides for businesses. There will be a prompt for a business to create a new account or sign in to their existing account. Clicking on “about” will bring the user to a page outlining a mission and “contact” will bring forward the software provider's contact information.

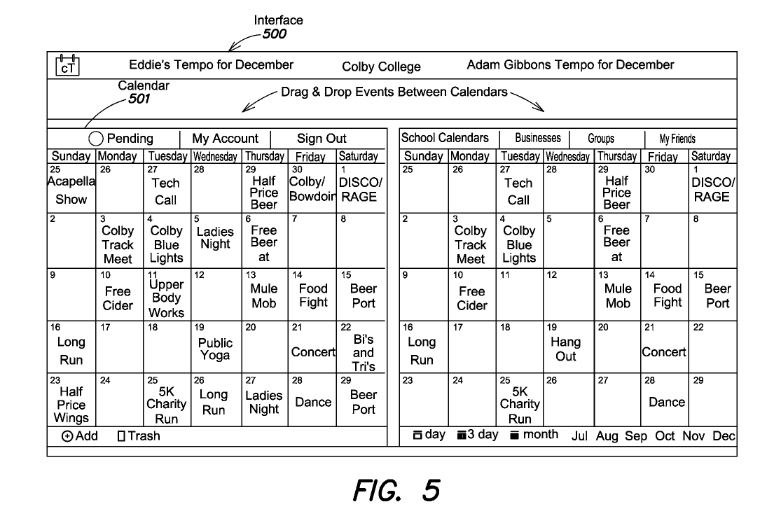

An interactive student home page may be provided wherein any user who has signed in may be immediately directed to the student home page. For example, FIG. 5 shows an example home page including a personal calendar (e.g., calendar 501) and one or more social calendars. The home page, as described in detail in the design section, may include a personal calendar, social calendars, and the functional buttons needed to navigate and use this utility.

An interactive businesses home page may be provided wherein after the business owner signs in, he or she will be immediately directed to the business home page. This page will look similar to the student home page. However, the business promotion calendar will replace the personal calendar on the left half of the page, and the right half of the page will display the all-school social calendar. In one embodiment, the business owner can cycle between the all-school public calendar and a highlighted local business promotional calendar.

Details Privacy Page—The user will be able to read and adjust privacy settings. Full details concerning privacy settings are discussed further below.

About Page—In the home page (for both students and businesses), the user may be provided the option to learn more about the CollegeTempo system by clicking an “About” link. This link will bring up a popup detailing the CollegeTempo system's use, mission, management, and contact info.

Mobile Application—Details relating to various implementations of a mobile application are discussed further below.

### Student Users

The CollegeTempo system may allow students to collectively build their schedules based on their own personal activities, what their friends are doing, what the school is scheduling and what local businesses are offering, and this may occur in real time:
1) Students can easily invite friends, or groups of friends to events, see what events their peers are attending and even see what events are most popular in the community within any given time period.
2) Students may be provided the ability to host “sponsored” events in which peers pledge in order to attend.
3) Students may be permitted to buy crowd—“Groupon” type deals at local businesses and view daily specials. Students can see within the interface, which local deals their friends have pledged, easily join into pledge deals, and encourage/invite other friends to do the same.
4) Students will be able to easily drag school events, personal commitments, student sponsored parties and local deals from communities', groups', and friends' calendars into their own CollegeTempo calendar to conveniently plan for shared events.

### Layout and Design

A student user's home screen will primarily include a personal calendar located on the left half of the screen and social calendars which are rotated into the right side of the screen that are accessed via tab buttons located directly above the social calendar. Various buttons and links, as explained below will be present for the user to navigate the features within The CollegeTempo system. This page, according to various implementations, may be simple, clean, functional, and easy to understand. A new user who initially logs in should see that their personal calendar is blank, but the all-school popular calendar (default view) should be full of school events, local bar promotions and specials.
All-School Calendars

The default screen for any student user may bring his or her “personal planner” to the left side of the screen and the “Popular” all-school calendar to the right side of the screen. This “popular” all school calendar may, according to one embodiment, be a culmination of the most popular events within every all-school category. Users can easily drag any public event from to the social all-school calendar into their own calendar. Doing so will increase the attendance count for that particular event. Likewise, dragging this event to the trash will decrease the count. By clicking on the All-School Public Calendars button on the top of the social calendar, the user will be presented with a dropdown list of the various all-school calendars. These options will be: Popular (default), Local Specials, Sports, Arts, Greek, Nightlife, Fun, Misc. By selecting any of these categories, the public events for each category will appear in their respective calendars. A user may alternate between a day, week, or month view for any of these calendars. Users can post to the all-school calendar by selecting the “Public Event” option when creating a new event.

### Local Specials Calendars

By selecting the “Local Specials” calendar by clicking on a button on the top of the social calendars, the user will be directed to a calendar that showcases the specials local businesses have chosen to highlight. As with all calendars, the most popular events will be coded red, all events will have attendance statistics, and the user can double click on any event or special to view more details. Upon clicking the “Local Specials” button, in addition to the calendar highlighting all local specials, the user may also sort by category. The second row of buttons will switch to various categories (Food and Drink, Nightlife, Spa/Salon, etc.) so that the user may view specials as organized by their genre. A local business will be given one of these labels upon creating an account so that their specials are sorted automatically.

### Business Calendars

Any student user can view the personal promotional calendars of a local business. This is similar to how one user would view a friend's calendar. (However, according to this embodiment, local business would not be able to view user's calendars). Local business calendars can be viewed by selecting the “Businesses” tab above the social calendars. Clicking on this button will bring down a drop-down list of all the local businesses that have accounts in the CollegeTempo system. By selecting a specific business, their promotional calendar fills the right half of the screen. A student user is permitted to then drag any event from this calendar into his or her own calendar.

### Creating Groups

According to one embodiment, students are permitted to invite friends to form groups, thereby creating group calendars. Students are able to join an unlimited number of groups with a professional account, but can manage a limited number (e.g., 10) with a free account. Students either create their own groups or may be invited into preexisting groups. When a user selects the “Groups” button present on the top of the social calendar, a second line of buttons may change to display the groups the user is currently in. One button will display a link to create a new group. When the user selects “Create New Group” a popup window will prompt the user to enter the new group title, the names of users (who are already using the CollegeTempo system), or ask the user to enter the email addresses of those people they wish to invite. If the CollegeTempo system recognizes the email of a user who already has an account, his or her name will be automatically added to the Names category. A link will also be generated for the group creator to copy and send over the web, to invite group members. If a group member clicks on this link, through Facebook for example, they will be promoted to create/sign into their the CollegeTempo system account. Upon logging in, they will have joined the group. For an existing group, any user in the group may invite another user by repeating this process through clicking the invite members button located on the top of the group calendar. The top of the group calendar will also have an option to leave the group if the user so desires. Groups have at least two (2) people. If there is only one member left in the group, the group may be deleted automatically by the system.

### Group Calendars

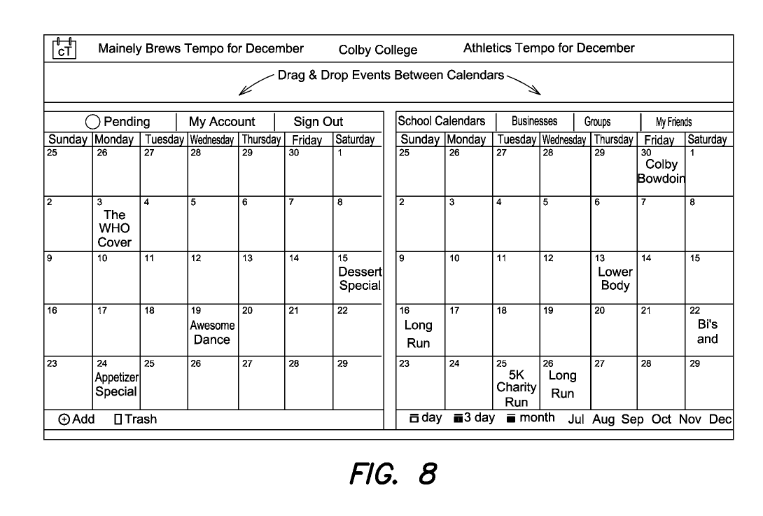

A user may be permitted by the system to form private group calendars based upon their social groups at their college or university. Sharing group calendars may allow sports teams, Greek organizations, roommates, musical groups, etc. to manage a group schedule and plan for shared events. There is no limit to the number of individuals in any particular group. By dragging any event from one's personal calendar into the group calendar for which they are a member, the event will be labeled as “pending” in the group calendar for other group members, and designated as such until the member either drags the event from the group calendar into their own or confirms the event in their pending event list (explained later). A pending event may be noted by a star in the event's top right corner (in the group calendar). to Upon dragging a pending event into one's personal calendar, a user will be permitted to view which other members have similarly confirmed this event. Users who invite group members to an event by dragging a personal event into a group calendar will automatically add this event into their pending events list. According to one embodiment, declining a pending group event will not remove this event from the group calendar, but this action will remove the pending event from the user's pending event list. The user may be provided the option to opt in for email notifications for all new pending events. An example interface of a group calendar with group events is shown by way of example in FIG. 8.

### Friends

Users will be able to “friend” other students or other user types which will allow personal calendar sharing. Friends will be able to view events in each other's calendars, except for those events a user designates as “Hidden.” A user may view another friend's calendar by selecting the “Friends” tab on top of the social calendars and selecting the friend from the second row of buttons that have now changed to display friends' names. Upon clicking on a specific friend's name, the right side calendar will switch to display the friend's calendar.

To gain a new friend, the user may select the “Invite Friend” button within the interface. Upon selecting this option, a popup button will overlay the screen, prompting the user to enter the name or email of the user they wish to friend. This popup window will also contain a link for the user to send over various existing web networks. When the recipient of this friend request clicks on the link, either in their “Pending Events” list, in their email, or on Facebook, they will log in and find they are now friends with that user. Similarly, the system may import “friends” information from one or more external sources.

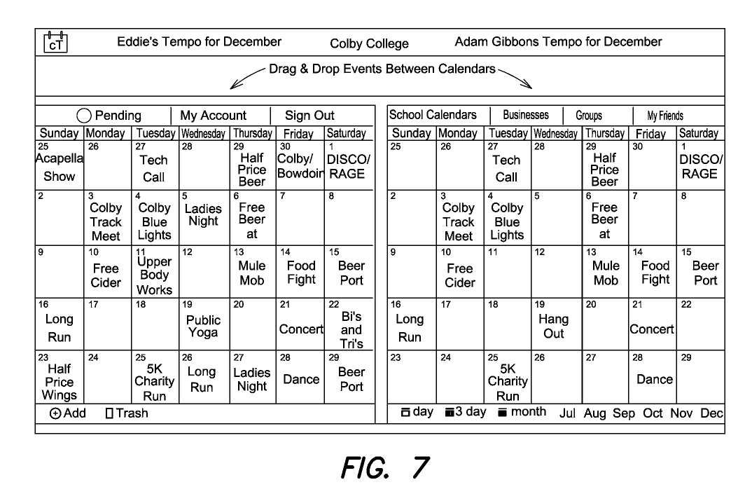

Students can easily invite friends to events by dragging an event from one's personal calendar into friends' calendars. Such an event would then be listed in the friend's pending event list. An example interface of a friends calendar is shown by way of example in FIG. 7.

### Creating Events

A user may create an event by selecting a create event button located at the bottom left of the page or by double clicking on any free space in their personal calendar. If the user is in “one day” view, clicking a blank space in their calendar and dragging downwards will also create an event with the time specified by the distance the user drags. (i.e. from 2 PM to 4 PM). to Upon clicking create event, double clicking, or dragging, a popup bubble will appear prompting for event details. Inputs include: Hidden-Exclusive-Public, Title, Date (this should only be blank if the user selects the “create event” bubble), location, time, (this should be automatically filled in if the user clicks and drags in day view), Recurring—by day, week, month, special—on certain days, e.g., MWF. A user may select an event as a “Public” event. If this option is chosen, the user designates the genre of the event. An option for “Sports, Arts, Greek, Misc. etc.” will sort this event into the appropriate all-school calendar. Public events are not listed as recurring events. A “Create Event” bubble will close the window and add the event into a user's personal calendar.

A link will be available within the “create event” bubble to create a sponsored event. If the user is already a paying user (e.g., a “professional” or “pro” version), options to specify a dollar amount, and number of students required for the event to occur will appear. If the user is not a paying pro user, a message prompting the user to create a pro account will occur. There will also be a link for an option to upload a picture. Like the “Create Sponsored Event” link, clicking on “add picture” will prompt the user to upgrade to a pro account or prompt the user to upload an image file (e.g., a JPG file).

### Inviting People to Events

Inviting a friend to an event is as easy as dragging the event from your own calendar into your friend's calendar. A user may also invite all the individual members of a group by dragging an event from their personal calendar into the group calendar. If a user wants to invite a peer who is not a friend or part of a group to an event, the user may do so by dragging the event to the “people” button listed on the bottom left of the screen. If the user is not a member of the CollegeTempo system, one can invite another by sending the QR-code or link associated with the event over email or through other existing forms of media.

### Dragging Events

A user may drag an event from any of the social calendars (on the right side of the page) into their own calendar. By dragging an event from an all-school public calendar, a group calendar, or a friend's calendar, the event will note your action in the “attendance” numerical statistic associated with the event. If you dragged this event into your own personal calendar, by double clicking on the event to bring up event details, you will also be able to see to the names of other students who have also signed up for this event. A user may drag an event from his or her personal calendar into either a group or a friend's calendar. A user will not be able to drag an event into the all-school calendars. (If a user wants the event to appear in the sorted All-school calendars, the user designates the event as public when creating the event). Users may drag any event from their personal calendars into the “Trash” icon located at the bottom left of the page if they choose to remove the event from their schedule. A user may not remove a sponsored event for which they have already been charged. Dragging a recurring event from a group, or friend's calendar into one's own will prompt the user to confirm whether they would like to drag the entire series. Likewise, dragging a recurring event from one's personal calendar into a group calendar will prompt the user to choose if they would like to drag the entire series of events. If there is a scheduling conflict (overlapping events) the user will be prompted to confirm he or she would like to move the events anyways. The overlapping events will be listed next to one another (in day view), and under one another in month and week views.

### Exclusive Events

Events that a user shares with individuals or a group, but does not publicly broadcast to the entire school are created as “Exclusive Events” Exclusive events will be visible to the user's friends who view his or her calendar. Such events might include “Soccer Team Practice,” or “Roommate BBQ,” which the user would share with his soccer team group or roommates, and permits his or her friends to see this event, but not the entire school. Users cannot drag exclusive events into their own calendars from the calendars of their friends. A user drags an exclusive event into his or her group calendar, or directly into the calendar of his or her friends. Any user can view the exclusive event their friends are in, but must create their own, or be invited to participate in an exclusive event. After accepting an invitation and joining an exclusive event a user will be able to see the guest list.

### Hidden Events

A user may designate any event as “Hidden” by selecting this option when they create an event in their personal calendar, or by clicking on the “H” in the top right of the specific event bubble in their personal calendar. A Hidden event will not be visible to anyone except for the user. An event will also be designated as Hidden through its designated color. The user to may select any color they wish to be associated with the Hidden event in their account settings.

A user may drag a Hidden event into a friend's calendar, but will not see if the friend has dragged this event into his or her own calendar. Furthermore, the friend will not know who invited them to this hidden event. By double clicking on a hidden event to bring up event specs, any user may see how many people are attending, but not who is attending. A user can designate any event (even public events) in their calendar as Hidden at any time. Their name will not appear in the attendance list for this event.

### Changing Events

The business owner will be able to change the details of a local business special or event. The user that created a public event will be able to change event details for the public event.

Any user who has replied positively to an exclusive event may switch the event details. A user may switch the time and details of any Exclusive event shared between friends or a group, although doing so will remove the event from the calendars of all those it is shared with, and it will appear again as a pending event invitation. This change will be reflected in the personal calendar of the user that changed the details. For all other group members, the event will be removed from their personal calendars and appear as a pending event.

A user can move an Exclusive event that is not shared with anyone, or a Hidden event in one's personal calendar by dragging the event to a new time (in day view), or new day (in week or month view).

According to one embodiment, users are not permitted to change the event type after the event is created. (e.g., from hidden to exclusive).

### Selecting an Event

By double clicking on any event, either a promotion in the personal calendar, an all-school sporting event, or a highlighted special from another business, a bubble will overlay the screen outlining the details of this event. This applies to all users, both students and business owners.

### Event Specifications

Events will appear in the day view as a bubble stretching from the beginning time to the ending time. In the week view, events will appear as organized bubbles listed under the appropriate listed day. In the Month view, event titles will appear in their respective colors in the appropriate day box.

Upon selecting (e.g., double clicking) any event, event box, or event title, a bubble will overlay the screen outlining the event details. Event Details will include: Title, Date, Time, Description, Picture (if applicable), and Information regarding Price and attendance Quota (applicable for sponsored events). A link may be available to add the event to one's personal calendar. A link may also be available to generate a QR code associated with the event. If a user has not added a particular event into their own calendar, according to one embodiment, they will be able to view how many people have replied for the particular event, but not who is going. Once a user adds an event to their own calendar, (by dragging or selecting add), the user may be permitted to view who (by name) is going to the event. As mentioned, users who designate any event in their personal calendar as “Hidden” will not appear in the guest list.

### Pending Events

If a friend drags an event into one's own calendar or into the calendar of a group of which one is a member, this event will appear as a pending event in the group calendar as well as in the personal list of pending events. A list of pending events, much like an inbox for events and notifications, may be able to drop down within the interface (e.g., on the right side of one's personal calendar). This list may contain both pending events and pending friend and group invitations. In a default view, the pending list may be collapsed up into its button/link, (located on the top right of the personal calendar), with a bubbled number designating how many pending invitations the user currently has listed. Upon selection of this button, the list will fall down the right side of one's personal calendar. A user may select a checkmark or an X to confirm or reject this event. By selecting the event within the interface, (not the check or X) the event details will overlay the screen. When an event is pending, the user will be shown who invited them to the event, or which group member posted the event to a group calendar. If a user is invited to a hidden event, they will not know who invited them.

### Flagging Inappropriate Events

Every event will have a small flag located in the bottom right corner. Users will be informed that by clicking on this flag, the user reports the event as inappropriate. This will to allow a community to self-police events. Local businesses can not have flags on their events. Local businesses may be required to abide by the terms and conditions upon creating a business account within the CollegeTempo system, which may include the requirement of posting no inappropriate events. If more than a specified number (e.g., 10) users report a student event as inappropriate, the event may be automatically removed from the CollegeTempo system.

### QR-Codes

According to one embodiment, events have a respective QR code associated with each event. If “Generate QR-Code” is selected, the QR code will appear as a popup with options below the code to download or share. Downloading the QR-Code will download the QR code for that event as a JPEG. By selecting share, the user will be presented with a link to the event they can share over existing forms of media. Upon clicking this link, a user adds this event into his or her calendar. Upon scanning a QR code with their CollegeTempo application for accessing the CollegeTempo system, the user will import this event into his or her calendar.

### Paid “Sponsored” Events

Certain events will involve financial transactions. Crowd-Deal Bar/Business events, as well as Student Sponsored Events can require that the user pay electronically to add this event to their calendar. The user either uses the credit card they have on file with The CollegeTempo system, or enter their credit info to add a sponsored event to his or her calendar. If a user has chosen (in their account settings) to keep a credit card on file, there will be a confirmation message (e.g., Only select “I agree” if you trust the inviting party or event. CT is not responsible for any action on behalf of the paid party. You will not be charged until the required number of people has been reached. You can remove this event until the required number of people has been reached./The required number of people has been reached, you will be charged immediately for this event. This action cannot be undone) If there is a fee, the user will receive an email receipt with their payment information. Proof of purchase may also appear in a specified section in their mobile application

### Student Sponsored Events

A user who has paid to upgrade to the “pro” or “professional” account will have the ability to “crowd fund” for his or her own sponsored events. For example, if a student wanted to host a BBQ but did not want to front cash for the food and drink, the student could invite friends and groups to a crowd-funded event where no one would be charged until the monetary goal is reached. If a user wanted to sell tickets online for a show or concert, the user could also use this feature. Students will be able to host paid events, charge admission, or preemptively raise funds for any event or initiative. As with any public event or local promotion, enough positive RSVPs will automatically promote a public event in the “popular” all-school calendar, encouraging others to join. The student who hosts a sponsored event has a paypal or google checkout account set up, and will do this upon upgrading to a “pro” account.

### Community Button

All members in a specific college community with an account defined in the CollegeTempo system will be listed by name under the “People” button (unless they choose to opt out in their account settings). This will allow a user to individually invite any user to any event through The CollegeTempo system. A user will not be able to “select all.” If more than one person is invited to an event, the user drags the event to the people button, then selects the invited person. This functionality may serve to prevent spamming.

### Color Coding Events

Students will have the ability to specify a color to be associated with different genres of events in their personal calendar. These color settings can be managed in the user account settings. Users will designate a specific color associated with “Hidden” events, Exclusive events, and public events. Default colors will be assigned until the user selects specific colors. A user may also create his or her own categories for a particular series of recurring events, and sort recurring events into categories, such as a color for “Classes,” or a specific color for “Homework.” The color schemes can be changed in the account settings. The account settings will list recurring events, and allow the user to put these events into labeled categories that are associated with a color.

In the social calendars, events will change from green to orange to red as they increase in popularity allowing students to easily and quickly view the most popular events within the community. These color distinctions will be relevant to the calendar they are in. For example, The Football game, which has 500 in attendance, is red in the sports all-school calendar, but is to yellow in the Popular events calendar if there is another event, a concert, for example, with 1000 attending. Popularity will be measured on a relative scale. Colors associated with all-school events will continue to switch between green, yellow, and red even inside one's personal calendar. Green, Yellow, and Red will not be available for the user to select in determining their personal categorical color scheme.

### Professional Account

A link to upgrade to a professional account will be present on the bottom right of the page. Upon clicking this link, the user will be taken to their account settings, with details outlining what they receive by paying for the pro account. A user can enter their credit information, (e.g., PayPal or GoogleCheckout account) and the logistics necessary to deposit funds into this account. Details of the capabilities of different account versions may be as follows in Table I below:

TABLE I

| Capability: | Free Version | Pro Version |
|---|---|---|
| Personal Planner: | x | x |
| Create Events: | x | x |
| Mobile Application: | x | x |
| Pledge to Local Deals: | x | x |
| Social Group Calendars: | 10 | Unlimited |
| Friends: | 10 | Unlimited |
| Host Paid Student | — | x |
| Sponsored Events: | | |
| Add an Event Photo: | — | x |
| New Skins: | — | x |
| Price: | Free | $3.95 per Month |

### SignOut, Make Favorite/Homepage

A link to sign out will be present on the top right of the page. There will also be a link that will allow the business or student user to make the CollegeTempo application a Favorite in their web browser or to setting the CollegeTempo application link as a homepage. The user can also select to “stay signed in” so that they do not have to enter their business/user name and each time they log on (users still have to enter their password for security purposes).

### Day, Week, Month Buttons

The local business or the student user may view both their own and the all school calendars by the day, week, or month by selecting the appropriate button located on the bottom center of the page.

### My Account

A user will have access to their account in the CollegeTempo system by selecting the “my account” link on the top center of the page. This page will contain information regarding the preferred method of payment on file, Color Coding options, and a history (receipts) of past paid events. This page will also have an option for a user to upgrade to a pro account, manage pro account settings, or to unsubscribe from an existing pro account. Privacy concerns will also be listed on the bottom of this page. A detailed summary of what information is kept private to whom will be listed. The users groups and friends will also be listed in this section. The user will be able to leave groups and “unfriend” any user in this section. A “Block List” can also be managed in this section, by which a user can hide himself or herself from any individual by entering his or her name or email address.

### Detailed Privacy Concerns

A message outlining privacy will be present on the bottom of the page for the first few to weeks following the launch at any particular school. The message will roughly read as follows: “CollegeTempo understands your privacy concerns. Only the information you want to share will be shared with those you want to share it with. No school administrators, potential employers, parents without permission, etc. will ever be able to see your schedule. Click here for more information.” Upon clicking this message, the user will be directed to the bottom of the My Account page, which will have security concerns detailed.

Events that a user designates as “Hidden” will be distinguished by their color, and by an “H” that will appear in a bubble on the top left corner of the event. Hidden events will only be visible to the individual user.

A user's calendar will be visible to those they have established as friends. Friends will be able to view each other's calendars—the public and exclusive events the user has listed in their schedule. Friends will not be able to view other friends' pending events. Members of the groups you are in will not be able to view your calendar, unless they are also designated friends.

According to one embodiment, nobody will know what groups a particular user is in. That is, in one implementation, group information for a particular user may be displayed to and controlled by only that user.

While your attendance is always counted as a numerical statistic in public and exclusive events, your name is only visible to those members who are also attending the particular event.

### Local Businesses

Local businesses will pay a fee for the opportunity to highlight daily specials and promotions in an all-school social calendar. Businesses can also post “crowd deals,” similar to Groupon. Students will be able to pay for these deals directly through the CollegeTempo system, and users will be able to view which deals their friends have pledged, easily invite or encourage other friends to join the deal, and see which deals are most popular. Students will be able to redeem these deals at businesses by displaying a receipt on their mobile phones, or by printing an emailed receipt.

### Layout

The “Local Business” home page will look similar to the student home page, except for a few functional buttons. The Business calendar will be present on the left half of the page. This calendar is used by businesses to organize their promotions and specials as well as showcase this information to students. Information entered into the business calendar will be public for students who view this specific business calendar in their social calendar. A business may drag any special from their “personal” promotional calendar into the all school calendar on the right half of the page. Performing this action will display this event/special in the all-school “Business Promotions” social calendar for student users. Various functional buttons as outlined in this document will be available for businesses to utilize CollegeTempo.

### Permissions

Just as any student is allowed to create an unlimited number of events in their personal calendar, any business will be able to create an unlimited number of events in their own promotional calendar.

Any local business owner may drag a specified number of events and promotions per month as established by their prepaid account with the CollegeTempo system.

The local business will have access to view the all-school public calendars and sort by the same options available to students. (Popular events, business promotions, arts, sports, etc.) However, a business will not be allowed to view the “personal” promotional calendar of other businesses as students can.

If a business does not use all of their credits for the month, their credits will transfer into the next month. A maximum number of credits will be set per month for any business.

### My Business Account

A link on the bottom right of the page will allow businesses to view their account settings and statistics. Upon clicking this link, the business owner will be directed to another page containing their account settings, (Business Name, Address, Phone, Email, Picture, login name and password), and their business details. Business details include their credit and payment information, the past highlighted promotions—and how many people signed up for past promotions, the number of available promotions they are permitted this month, and their gross “deal” income. The business owner can edit their account settings or cancel their CollegeTempo account if they choose to do so. A “help” email link and phone number will be to available for Businesses to contact CollegeTempo staff.

### Creating a Promotion

A business owner may create an event promotion by clicking on the “Create Promotion” button (similar to the “create event” button for students) located on the bottom left of the page, or by double clicking the exact date, or clicking and dragging within any blank space within their personal calendar. By performing this action, a bubble will overlay the screen prompting the business owner to enter details regarding this promotion. Prompts for details will include the following options: Type of Deal—the user selects “Special,” or “Crowd Deal.”

If the “Special” setting is selected, the business specifies the name for the special, the time, the date, and if the special is recurring. The user may optionally enter an additional 4 lines of description if they choose to do so. If it is a recurring event, the user selects if it is recurring by day, week, month, etc. Upon entering this information and clicking “create,” the special then appears in the personal promotional calendar of the business. This special will be visible for any student who views the promotional calendar of this business.

If the “Crowd Deal” setting is selected, the business specifies the name, the title, and the date, and optionally enters a description. Crowd deals will not be created as recurring events. Additional specifications for the Crowd Deal are selected, including the number of students who must sign up for the deal for the deal to become live, and the price. An option will be available for the business to automatically display this event in the highlighted all-school “business promotions” calendar. This option will be available if the business owner has available credits. Upon clicking “create” at the bottom of this popup bubble, the bubble will close and the Crowd Deal will be present in the promotional calendar of the business (and in the all-school highlighted calendar if applicable).

### Miscellaneous Features

According to one embodiment, users will not navigate “forward” or “backward” as they would on a traditional website. There is one interactive page that contains the tools to work within the CollegeTempo application.

### Mobile Application

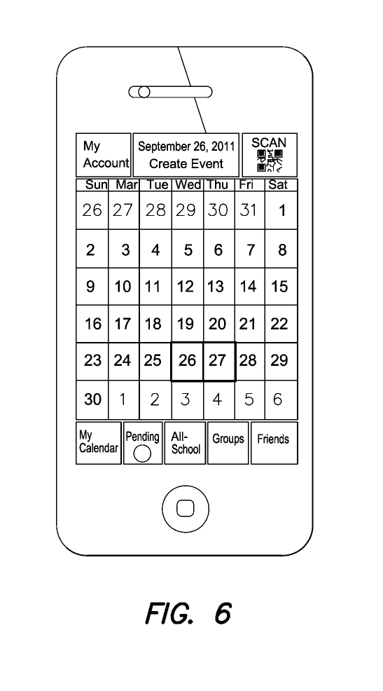

The CollegeTempo system may include a mobile application that will have the capabilities of the browser-based website. The mobile application may include personal and social calendars, and may serve a function for a business association with local businesses, and for interaction with QR-codes. One example interface of a mobile application is shown by way of example in FIG. 6. The mobile application may be formatted as follows: The bottom will have options for My calendar, Pending, All-school (which will prompt the user to select which all school calendar), Groups (prompting the user to select his or her group), and Friends (prompts the user to select which friend's calendar they wish to view). The top will contain the options to sign in/out/manage one's account, create an event, and scan a QR-Code. Upon selecting “My Account and Deals” a user may be presented a list of any local deals they have paid for. Upon clicking a specified deal, a receipt for the deal will appear, and the business owner can sign this receipt to redeem it

### Financial Transactions Summary

Financial transactions may be conducted online through the CollegeTempo system using, for example, Paypal, Google Checkout or similar service(s). The following is a list of several possible transactions.

Local Businesses:
Pay CollegeTempo online (after specified time period) to continue use of the CollegeTempo system
Can receive money from the CollegeTempo system operator (from students who pay for crowd deals)

CollegeTempo:
Can transfer $ between student accounts (pledges to student deal hosts)
Can collect $ from students for who pay for professional accounts
Can transfer $ to local businesses (Students who pay for deals)
Can collect $ from local businesses (businesses who pay the CollegeTempo operator)

Students:
Can pay the CollegeTempo operator to upgrade to a “pro” account.
Can pay CollegeTempo to buy deals from local businesses.
Can pay CollegeTempo online to pledge to student-sponsored events.
Pro users can receive payments from other student pledges.

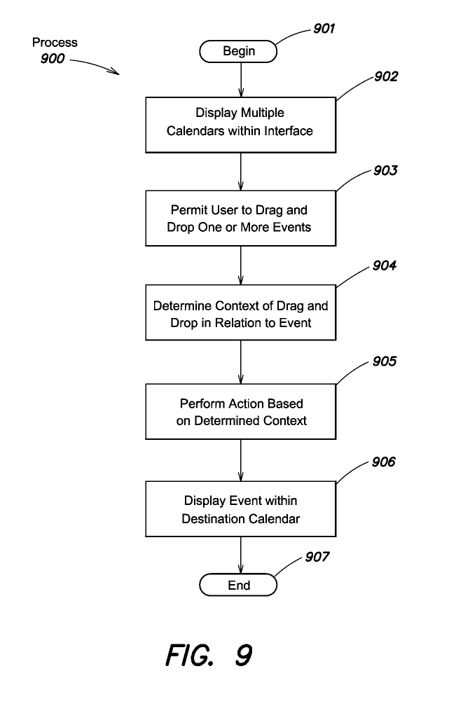

FIG. 9 shows an example process 900 for working with calendars according to one embodiment of the present invention. At block 901, process 900 begins. At block 902, the system (e.g., the CollegeTempo system) displays multiple calendars within the interface to a user. For instance, the interface may display the personal calendar of the user along with one or more other calendars associated with other people, groups, or other entities. At block 903, the system permits the user to drag and drop one or more events between the displayed calendars. For instance, the user may elect to drag and drop an event from a social calendar onto his/her personal calendar. At block 904, the system determines a context of a drag and drop in relation to the event. For example, in the example above, when the user drags and drops an event onto his/her personal calendar, an RSVP may be sent to the group regarding the event just subscribed to by the user. At block 905, the system may perform an action based on the determined context (e.g., send an RSVP message). At block 906, the system may display the dropped event within the destination calendar (e.g., the user's personal calendar). At block 907, process 900 ends.

It should be appreciated that the invention is not limited to each of the embodiments described herein, but rather, various embodiments of the invention may be practiced alone or in combination with other embodiments. For example, while many of the embodiments above have been described using the example of a college campus, embodiments are not limited to a college campus. For example, a community can be a town, a church or other religious community, a business, a school, a city, or any other appropriate group of people.

What is claimed is:

1. A method for managing schedules, the method comprising an act of:
providing, by a server system to a computer, a user interface displaying at least a first and a second calendar, the user interface providing for interaction by a user between the first calendar and the second calendar to affect events on at least one of the first and the second calendars.

2. The method according to claim 1, wherein the first calendar is a personal calendar of to the user.

3. The method according to claim 2, wherein the second calendar is associated with an entity including at least one of a group comprising a friend, a group, an organization, a school, and a related entity.

4. The method according to claim 1, further comprising an act of providing, to the user, a capability for dragging and dropping events between the first calendar and the second calendar.

5. The method according to claim 4, further comprising an act of sending, responsive to an act of dragging and dropping an event to the first calendar, a message indicating that the user is attending the event.

6. The method according to claim 4, further comprising an act of advertising an event, responsive to the act of dragging and dropping the event to the first calendar.

7. The method according to claim 1, further comprising an act of receiving an advertising payment for displaying one or more events on the second calendar.

8. The method according to claim 4, further comprising an act of performing an action responsive to the act of dragging and dropping an event to the first calendar.

9. The method according to claim 1, wherein the first calendar is a public calendar accessible by other users and wherein the user is permitted to post an event to the public calendar.

10. A system for managing schedules, the system comprising:
a processor;
a memory coupled to the processor;
a storage system configured to store a plurality of events associated with one or more people and activities;
an interface adapted to display at least a first calendar and a second calendar, the interface providing for interaction by a user between the first calendar and the second calendar to affect events on at least one of the first and second calendars.

11. The system according to claim 10, wherein the first calendar is a personal calendar of the user.

12. The system according to claim 11, wherein the second calendar is associated with an entity including at least one of a group comprising a friend, a group, an organization, a school, and a related entity.

13. The system of claim 10, wherein the interface is adapted to permit the user to drag and drop events between the first calendar and the second calendar.

14. The system according to claim 13, wherein the processor is operative to send a message indicating that the user is attending an event responsive to the user dragging and dropping the event to the first calendar.

15. The system according to claim 13, wherein the processor is operative to display an advertisement for an event responsive to dragging and dropping the event to the first calendar.

16. The system according to claim 10, further comprising a component adapted to receive a payment for displaying one or more events on the second calendar.

17. The system according to claim 13, wherein the processor is operative to perform an action responsive to a drag and drop of an event to the first calendar.

18. The system according to claim 17, wherein the action is determined based on a context of the event being placed within the interface.
